(19) United States
(12) Patent Application Publication
(10) Pub. No.: US 2024/0199464 A1
(43) Pub. Date: Jun. 20, 2024

(54) Method and Apparatus for Eliminating Biofilm-Forming Bacteria in Water

(71) Applicant: McCoy Water Filter, Inc., Henrico, VA (US)

(72) Inventor: Brian Alexander McCoy, Henrico, VA (US)

(73) Assignee: McCoy Water Filter, Inc., Henrico, VA (US)

(21) Appl. No.: 18/084,128

(22) Filed: Dec. 19, 2022

(51) Int. Cl. C02F 9/00

(52) U.S. Cl. CPC C02F 9/00; C02F 2101/101

(57) ABSTRACT

A pressurized water treatment apparatus and method for use of such apparatus in eliminating biofilm-forming bacteria and other contaminants in water and eliminating bacterial biofilm infections in a potable water plumbing system downstream of the pressurized water treatment apparatus. The pressurized water treatment apparatus has an inlet port, a check valve, a 4-cycle control valve, an air injection assembly, a one-way pressure sensitive valve, a treatment tank body, compressed air pocket, copper-zinc media, garnet gravel media, a combined strainer-distributor basket, a riser tube, and an outlet port. The pressurized water treatment apparatus comprises four flow configurations: the normal flow configuration, the backwash configuration, the air injection configuration, and the rinse configuration. In the normal flow configuration, water flows into the top of and down through the pressurized water treatment apparatus, wherein biofilm-forming bacteria and other contaminants are eliminated from the source water by means of oxidation and redox reactions and mechanical filtration, oxygen is dissolved into the water and activated by means of redox reaction. Dissolved activated oxygen in the treated water flows into and throughout a connected water plumbing system eliminating bacteria biofilm infections in the water plumbing system downstream of the pressurized water treatment apparatus.

### FIELD OF THE INVENTION

The invention relates to a method and apparatus for treating water, specifically a method and apparatus for eliminating biofilm-forming bacteria and other contaminants in private or public water and eliminating bacterial biofilm infections in potable water plumbing systems.

### BACKGROUND OF INVENTION

The invention relates to a method and apparatus for treating private or public water supplies. Many water supplies contain one or more biofilm-forming bacteria including sulfate reducing bacteria (SRB), sulfur reducing bacteria (SRB), purple sulfur bacteria (PSB), green sulfur bacteria (GSB), iron bacteria (IB), slime-forming bacteria, and Pseudomonas bacteria. Biofilm-forming bacteria cause various problems including sulfur odors, tastes, slimy residues and black, gray, brown, red, orange, yellow and pink staining. Biofilm-forming bacteria infect potable and non-potable water plumbing systems and cause problems including corrosion of plumbing and clogged well and plumbing systems.

The prior art water treatment systems for controlling biofilm-forming bacteria consist of an apparatus that implements a form of treatment which may include chemicals such as chlorine, fluoride, or hydrogen peroxide, or filtration medias that may include catalytic carbon, manganese greensand or ion exchange resins. These treatments require constant and regular maintenance and produce environmental impact by consuming water treatment materials and creating waste materials. Chemical treatments require mixing solutions of water and chemicals on a regular basis and feeding the solution into contaminated water plumbing systems with a chemical feed pump. Feed pumps require frequent monitoring and adjustments due to fluctuations or variations in the quantity and nature of bacteria being treated, and fluctuations or variations in the rate of flow and chemical composition of the source water. Chlorine is the most common chemical treatment used to disinfect water and is well known in the art. Chlorine does not instantly destroy biofilm-forming bacteria on contact, allowing time for biofilm-forming bacteria to adapt and develop resistance to the treatment. Media treatments are preferred due to the ability to automatically regenerate, however environmental impact is a concern. Catalytic carbon becomes exhausted in time and must be removed, disposed of and replaced on a regular basis. Manganese greensand requires continual additions of poisonous potassium permanganate which regenerates the media and is flushed out into the environment. Ion exchange resins require continuous additions of salt (sodium chloride) which regenerates the media and is flushed out into the environment. The indefinite and continuous consumption of chemicals, media or salt makes these systems cost prohibitive, prone to treatment failure if not maintained, and bad for the environment. There exists a need for a water treatment apparatus (and accompanying method of use) which safely and effectively destroys biofilm-forming bacteria instantly, and also safely and effectively eliminates bacterial biofilm infections in potable water plumbing systems and is non-consuming, low maintenance, self-regenerating indefinitely and environmentally friendly.

### BRIEF SUMMARY OF THE INVENTION

It is therefore an object of this invention to provide a method and apparatus for treating private or public water supplies, including eliminating biofilm-forming bacteria and other contaminants and eliminating bacterial biofilm infections in potable water plumbing systems downstream of the water treatment apparatus.

It is yet another object of this invention to provide a method and apparatus for treating private or public water supplies with no need for media or chemical replacement or continuous material consumption by using filtration media that is regenerate-able indefinitely combined with abundant and ambient air, and thereby creating the least adverse impact to the environment.

The invention consists of a pressurized water treatment apparatus with an inlet port, a check valve, a 4-cycle control valve, an air injector assembly, a water treatment tank body, a compressed air pocket, a copper-zinc media, a garnet gravel media, a combined strainer-distributor basket, a riser tube, and an outlet port. The pressurized water treatment apparatus includes four flow configurations; normal flow configuration, backwash configuration, air injection configuration and rinse configuration. Timing and frequency of the four flow configurations are programmed into and controlled by the 4-cycle control valve.

In the normal flow configuration, the 4-cycle control valve allows private or public source water to flow into the top of and down through the water treatment tank body, wherein biofilm-forming bacteria and other contaminants are eliminated from the source water and oxygen is dissolved into the water and activated before the treated water is allowed to flow into the water plumbing system. Dissolved activated oxygen in the treated water flows into and throughout the water plumbing system eliminating bacteria biofilm infections in the water plumbing system downstream of the pressurized water treatment apparatus.

In the backwash configuration, the 4-cycle control valve allows source water to flow into the lower portion of and up through the water treatment tank body, wherein a rapid evacuation of the compressed air pocket coupled with the substantial aperture size and increased total flow area of the combined strainer-distributor basket allows water to be moved with a significantly increased initial flow rate to effectively lift and agitate the copper-zinc media. Lift and agitation coupled with a high rate of flowing water is critical in removing bacteria and other contaminants from the surface of the copper-zinc media, effectively cleaning and reactivating the copper-zinc media. Bacteria and other contaminants are carried away by flowing water to the discharge port of the 4-cycle control valve and then out of the pressurized water treatment system.

In the air injection configuration, the 4-cycle control valve allows source water to flow into an integrated air injector assembly. Water flowing through the air injector assembly creates a pressure differential that allows ambient air to flow in through a one-way pressure sensitive valve. Air flows out of the 4-cycle control valve and into the upper portion of the water treatment tank body, replacing oxygen used in the normal flow configuration and the compressed air pocket released during use in the backwash configuration.

In the rinse configuration, the 4-cycle control valve allows source water to flow into the upper portion of and down through the water treatment tank body, rinsing the copper-zinc media and garnet gravel media and compressing air into a compressed air pocket, preparing the pressurized water treatment apparatus for use in the normal flow configuration.

Aspects of the water treatment systems and methods are presented in various embodiments; however, one skilled in the art will understand various variations and interchangeability of the components of the various embodiments which are intended to be included in the scope of the invention.

### BRIEF DESCRIPTION OF THE DRAWINGS

The above and other objects, features and advantages will be more clearly understood and appreciated from the following Detailed Description of the present invention when taken in conjunction with the accompanying drawings which illustrate the four flow configurations of the pressurized water treatment apparatus:

FIG. 1 is an elevation of an embodiment of the pressurized water treatment apparatus partially broken away for clarity of illustration, with arrows schematically indicating the direction of water flow during use in the normal flow configuration.

FIG. 2 is an elevation of an embodiment of the pressurized water treatment apparatus partially broken away for clarity of illustration, with arrows schematically indicating the direction of water flow during use in the initial period of the backwash configuration.

FIG. 2a is an elevation of an embodiment of the pressurized water treatment apparatus partially broken away for clarity of illustration, with arrows schematically indicating the direction of water flow during use in the remainder period of the backwash configuration.

FIG. 3 is an elevation of an embodiment of the pressurized water treatment apparatus partially broken away for clarity of illustration, with arrows schematically indicating the direction of water flow during use in the air injection configuration.

FIG. 3a is an elevation of an enlarged view of the air injector assembly portion of the 4-cycle control valve which is activated only during use in the air injection configuration of FIG. 3 with arrows schematically indicating the direction of water and air flow during use in the air injection configuration.

FIG. 4 is an elevation of an embodiment of the pressurized water treatment apparatus partially broken away for clarity of illustration, with arrows schematically indicating the direction of water flow during use in the rinse configuration.

### DETAILED DESCRIPTION

The present invention relates to a pressurized water treatment apparatus for eliminating biofilm-forming bacteria, including sulfate reducing bacteria (SRB), sulfur reducing bacteria (SRB), purple sulfur bacteria (PSB), green sulfur bacteria (GSB), iron bacteria (IB), slime-forming bacteria, and Pseudomonas bacteria and removing contaminants, including soluble iron (Fe+2), insoluble iron (Fe+3), hydrogen sulfide (H2S), and sediments from private or public source water supplies and for eliminating bacterial biofilm infections in potable water plumbing systems downstream of the pressurized water treatment apparatus.

The present invention comprises a high purity copper-zinc media. Copper-zinc media destroys bacteria cells using an electrochemical reduction process or redox reaction. In the redox reaction bacteria cells are destroyed by contacting the reactive surface of copper-zinc media. To maintain the redox reaction in the water treatment apparatus copper-zinc media must be backwashed recurrently with a high rate of water flow to remove biofilm-forming bacteria and other contaminants from the media surface. The present invention accomplishes a high rate of backwash water flow by means of two innovations; a compressed air pocket inside the treatment tank body and a combination strainer-distributor basket inside the treatment tank body.

The present invention comprises a compressed air pocket with several functions; 1. Capture and or oxidize source water contaminants, including hydrogen sulfide and soluble iron, 2. Add dissolved oxygen to be activated by redox reaction for disinfecting a bacterial biofilm infected water plumbing system and 3. Significantly increase the initial water flow rate during the backwash configuration to aid in lifting and cleaning the copper-zinc media.

The present invention comprises a combination strainer-distributor basket with a significantly increased total flow area when compared to commercially available fine slotted strainer baskets known to the art and commonly used in the industry. The increased flow area of the combined strainer-distributor basket coupled with the rapid evacuation of the compressed air pocket during the backwash configuration accommodates an increased rate at which water flows through the present invention to aid in lifting and cleaning the copper-zinc media.

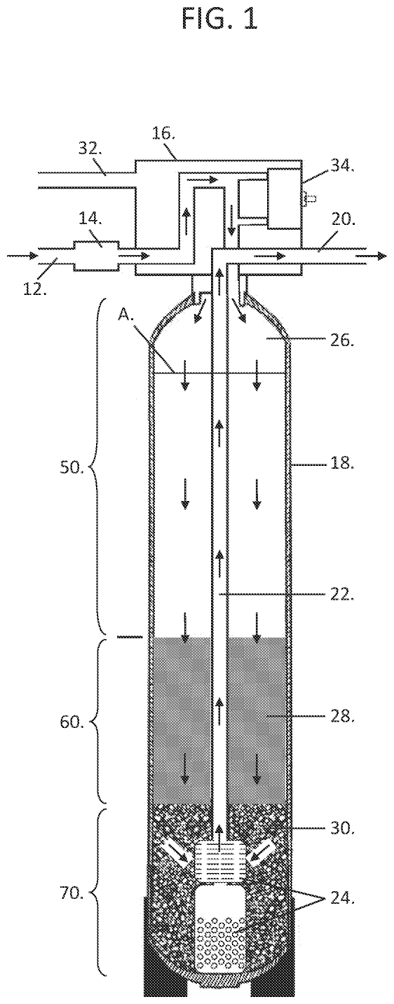

Referring now to FIG. 1, one embodiment of the pressurized water treatment apparatus comprises an inlet port 12, wherein the inlet port 12 is configured to be connected to a pressurized fluid source (not depicted). The pressurized fluid source may be, but is not limited to, non-aerated well water from a well pump or water from a public water system. The pressurized water treatment apparatus may comprise a check valve 14, which is connected to the inlet port 12. For example, the check valve 14 may prevent air from flowing out of the pressurized water treatment apparatus and into a source of non-aerated and untreated water. The pressurized water treatment apparatus comprises a 4-cycle control valve 16 and an outlet port 20, the 4-cycle control valve 16 being in fluid communication with the inlet port 12, and the outlet port 20 being in fluid communication with the 4-cycle control valve 16. The outlet port 20 may be connected to, for example, a residential or commercial potable water plumbing system.

The pressurized water treatment apparatus comprises a treatment tank body 18, the treatment tank body 18 being connected to the 4-cycle control valve 16. The 4-cycle control valve 16 is programmed to control the 4 flow configurations of the pressurized water treatment apparatus. The 4-cycle control valve may be, for example, a Fleck 2510-SXT-AIO control valve, although other suitable control valves with air injection capacity are well known in the art. The treatment tank body 18 is configured to contain pressurized gases and liquids and water treatment filter media, for example. The treatment tank body 18 may be made from many materials including, but not limited to, plastic, fiberglass, aluminum, steel, metals, or other materials that are capable of containing the pressure of the pressurized fluid source. The treatment tank body 18 may be, for example, a Clack 948 Mineral Tank, although other suitable treatment tank bodies are well known in the art. The treatment tank body 18 comprises an upper portion 50, a middle portion 60, and a lower portion 70. In an embodiment of the present invention, the various portions of the treatment tank body 18 are not physically separated components. In an embodiment of the present invention, the treatment tank body 18 has an inside diameter of between 8 inches and 13 inches and an interior height of between 40 inches and 54 inches. In additional embodiments, the treatment tank body 18 has different dimensions. In an embodiment of the pressurized water treatment apparatus, the 4-cycle control valve 16 is connected to the treatment tank body 18 at the upper portion of the treatment tank body 50. The 4-cycle control valve 16 is configured to regulate the flow of fluid into, out of, and throughout the pressurized water treatment apparatus, and has four flow configurations, including a normal flow configuration, a backwash configuration, an air injection configuration, and a rinse configuration. The 4-cycle control valve 16 may be automatically or manually controlled.

In the embodiment of the present invention displayed in FIGS. 1-4, the pressurized water treatment apparatus comprises a copper-zinc media 28 and a garnet gravel media 30. The garnet gravel media 30 is in the lower portion of the treatment tank body 70, and the copper-zinc media 28 is in the middle portion of the treatment tank body 60, above the garnet gravel media 30. The garnet gravel media 30 comprises a plurality of particles of said gravel. The copper-zinc media 28 comprises a plurality of particles of said media, and the size of those particles is often termed the mesh size in the art but may also be referred to using terms like fine, medium or coarse (with fine referring to smaller particles sizes, and coarse referring to larger particles). In an embodiment of the present invention, the garnet gravel media 30 is coarser than the copper-zinc media 28, and the copper-zinc media 28 is finer compared to the garnet gravel media 30. In an embodiment of the present invention, the copper-zinc media 28 comprises high-purity medium granular copper-zinc media. Copper-zinc media varies in form and composition, but its high-density particles distinguish it from other kinds of water treatment filter media. Copper-zinc media has a density of at least 100 lbs per cubic foot. In one embodiment of the present invention, the copper-zinc media comprises high-purity medium granular copper-zinc media and has a density between 120 lbs per cubic foot and 220 lbs per cubic foot. High-purity medium granular copper-zinc media or KDF 55 and KDF 85 (manufactured by KDF Fluid Treatments, Inc.) are merely two examples of copper-zinc media 28; additional embodiments of the present invention may comprise different types of copper-zinc media 28. KDF 85, for example has a density of 171 lbs per cubic foot. In one embodiment of the invention, the copper-zinc media 28 comprises between 40 lbs and 80 lbs of KDF-85. Additional embodiments of the present invention comprise different copper-zinc media 28 including, but not limited to, KDF-F, KDF-C, KDF 55, KDF 85, and combinations thereof. In an embodiment of the present invention, the garnet gravel media 30 comprises between 25 lbs and 75 lbs of Garnet #6. In another embodiment of the present invention, the garnet gravel media 30 comprises between 25 lbs and 75 lbs of Garnet #8, or some combination thereof. The size of the particles in the garnet gravel media 30 differs in different embodiments, including but not limited to Garnet #7 and Garnet #10.

The pressurized water treatment apparatus comprises a riser tube 22 and a combined strainer-distributor basket 24. The riser tube 22 is located within the treatment tank body 18 and is connected to the 4-cycle control valve 16, extending from the 4-cycle control valve 16 through the upper portion of the treatment tank body 50, through the copper-zinc media 28 in the middle portion of the treatment tank body 60, and into the garnet gravel media 30 in the lower portion of the treatment tank body 70 and is connected to the combined strainer-distributor basket 24. In an embodiment of the pressurized water treatment apparatus, the riser tube 22 may have an inside diameter of 15/16 inch and an outside diameter of 1 1/16 inches, although the riser tube 22 has different dimensions in additional embodiments. The flow area of the combined strainer-distributor basket 24 relate to rate at which water can flow through the riser tube 22, calculated with the interior diameter of the openings of the combined strainer-distributor basket 24 using the formula to calculate area. The flow area of the combined strainer-distributor basket 24 accommodates an initial flow rate increase in the riser tube 22 when water is flowing through the water treatment apparatus in the backwash configuration.

The combined strainer-distributor basket 24 is connected to the riser tube 22 in the lower portion of the treatment tank body 70 and is surrounded by the garnet gravel media 30. The combined strainer-distributor basket 24 defines an inner volume, and that inner volume is in fluid communication with the riser tube 22. The combined strainer-distributor basket 24 comprises a plurality of slots and apertures. In relation to the plurality of slots and apertures of the combined strainer-distributor basket 24, flow area refers to the area through which materials may flow. In an embodiment of the invention, the distributor portion of the combined strainer-distributor basket 24 has a width of 2.25 inches and the portion of the distributor basket 24 which comprises the plurality of apertures may have a height of 2.5 inches, although these dimensions differ in additional embodiments of the pressurized water treatment apparatus, based upon the configuration and other design restraints. In an embodiment of the present invention, each individual aperture in the plurality of apertures has a diameter that prevents the garnet gravel media 30 from entering the inner volume of the combined strainer-distributor basket 24 and riser tube 22 to interrupt operation of the 4-cycle control valve 16. In one embodiment of the present invention, the diameter of each individual aperture in the plurality of apertures is less than the diameter of the smallest particle of the garnet gravel media 30 adjacent to the apertures. The flow area of each individual aperture in the plurality of apertures varies between the various embodiments of the present invention. For example, in an embodiment of the invention, the plurality of apertures in the distributor portion of the combined strainer-distributor basket consists of 209 individual ⅛ inch round drilled holes in a 19×11 helical pattern, and the garnet gravel media 30 is Garnet #6. The total number and size of apertures in the plurality of apertures also differs in different embodiments.

The plurality of apertures has a size that prevents the garnet gravel 30 surrounding the distributor portion of the combined strainer-distributor basket 24 from entering the inner volume of the distributor portion of the combined strainer-distributor basket 24 and clogging the riser tube 22. In some embodiments, the apertures are less than ¼ inch and greater than 1/64 inch. In another embodiment, the apertures are between 1/16 inch and 3/16 inch in size. Typically, the apertures will be circular shape and the dimension of the aperture above will be the diameter. However, apertures of any shape may have the smallest opening size in the range above to prevent the garnet gravel media 30 from entering the inner volume of the distributor portion of the combined strainer-distributor basket 24.

The size of each aperture, as well as the total number of apertures in the plurality of apertures of the distributor portion of the combined strainer-distributor basket 24, contributes to the flow area of the distributor portion of the combined strainer-distributor basket 24. The size of the slots, as well as the total number of slots in the plurality of slots of the strainer portion of the combined strainer-distributor basket 24, contribute to the flow area of the strainer basket portion of the combined strainer-distributor basket 24. In relation to the present invention, total flow area refers to the combined (combined flow area of the plurality of apertures and combined flow area of the plurality of slots) or total area through which materials may flow. In the present invention, the distributor portion of the combined strainer-distributor basket 24 may have a total flow area between 2 square inches and 10 square inches. In another embodiment of the present invention, the distributor portion of the combined strainer-distributor basket 24 has a flow area of between 1.9 and 2.8 square inches, and the strainer portion of the combined strainer-distributor basket 24 has a flow area of 1.48 or 1.50 square inches.

In embodiments of the water treatment system, the combined strainer-distributor basket 24 has a flow area greater than 2 times the flow area of the riser tube 22 of the water treatment system; in a further embodiment, the combined strainer-distributor basket 24 has a flow area greater than 3 times to 6 times the flow area of the riser tube 22 of the water treatment system. In such embodiments, the strainer portion of the combined strainer-distributor basket 24 is in use primarily in the normal flow configuration, air injection configuration and the rinse configuration of the water treatment apparatus, and the distributor portion of the combined strainer-distributor basket 24 is in use primarily in the backwash configuration of the water treatment apparatus.

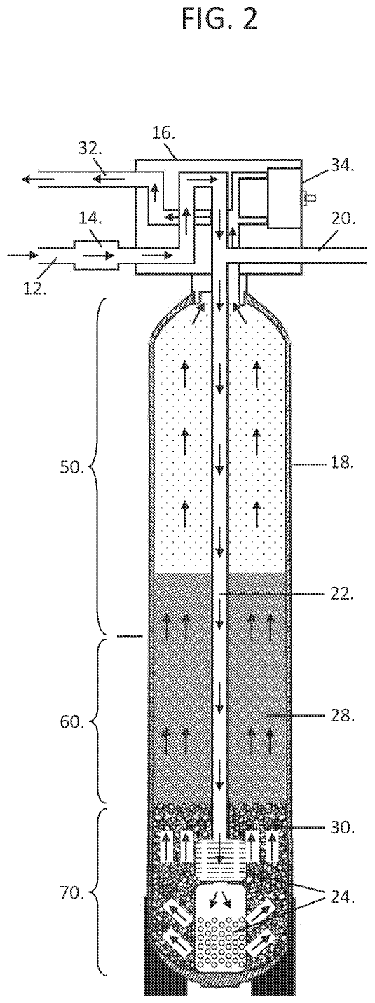

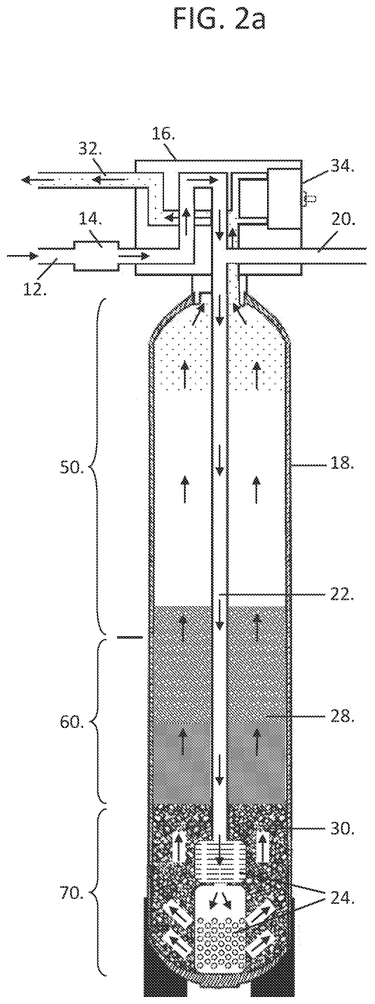

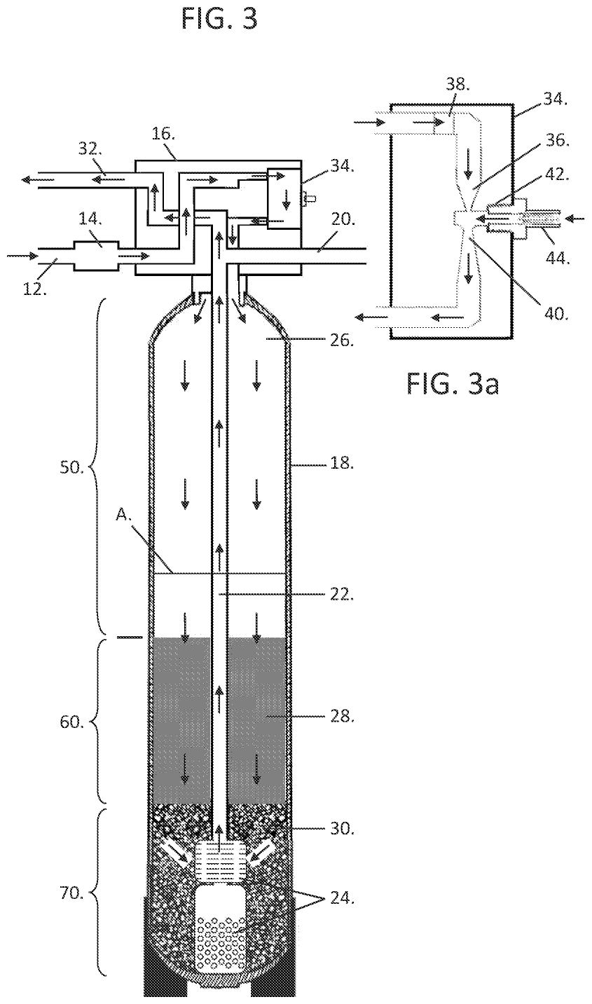

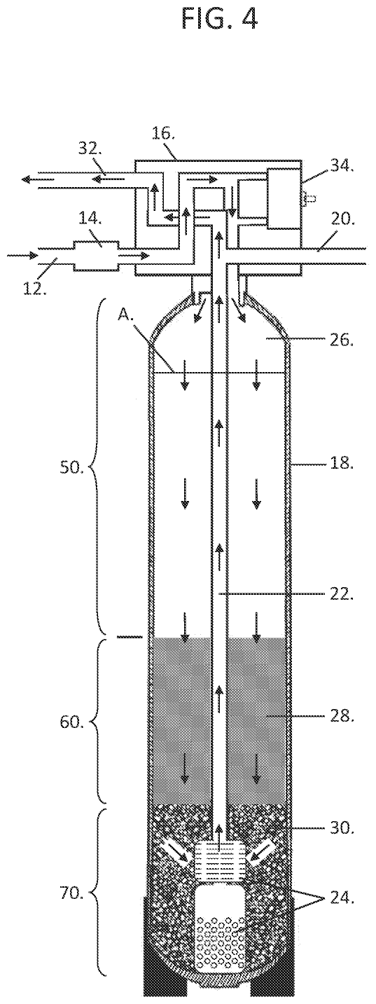

An embodiment of the pressurized water treatment apparatus comprises four flow configurations which may be used during the water treatment process, the normal flow configuration is depicted in FIG. 1; the backwash configuration is depicted in FIGS. 2 and 2a; the air injection configuration is depicted in FIGS. 3 and 3a; and the rinse configuration is depicted in FIG. 4. Referring now to FIG. 1, in the normal flow configuration, non-aerated source water flows into the inlet port 12 towards the 4-cycle control valve 16. The check valve 14 allows water to flow toward the 4-cycle control valve 16 but prevents any air from returning to the non-aerated fluid source. In the normal flow configuration, the 4-cycle control valve 16 allows the flow of water into the upper portion of the treatment tank body 50, causing the water to come into contact with the compressed air pocket 26 in the upper portion of the treatment tank body 50. The non-aerated water being exposed to air causes hydrogen sulfide and other materials to be released from the water and captured in the compressed air pocket 26. Oxygen in the compressed air pocket 26 readily dissolves in water under pressure, and the water just below water level A contains dissolved oxygen, bacteria, soluble and insoluble iron and other contaminants.

As the water continues to flow from the upper portion of the treatment tank body 50 to the middle portion of the treatment tank body 60, as depicted by the flow arrows in FIG. 1, biofilm-forming bacteria are destroyed in a redox reaction when contacted with copper-zinc media 28. The described oxygen reacts with soluble iron compounds. The oxidation reaction of Fe+2 to Fe+3 produces insoluble iron. Insoluble iron is captured by the copper-zinc media 28. Additional sediments in the water are also physically captured by the copper-zinc media 28. Dissolved oxygen is activated by the redox reaction in contact with copper-zinc media 28. The water continues to flow through copper-zinc media 28 in the middle portion of the treatment tank body 60 and flows down through the garnet gravel media 30 in the treatment tank body 18. The garnet gravel media 30 may capture and contain copper-zinc media 28, completing the filtration process for the water. After the completed filtration process, biofilm forming bacteria including sulfate reducing bacteria (SRB), sulfur reducing bacteria (SRB), purple sulfur bacteria (PSB), green sulfur bacteria (GSB), iron bacteria (IB), slime-forming bacteria, and Pseudomonas bacteria and contaminants, including soluble iron (Fe+2), insoluble iron (Fe+3), hydrogen sulfide (H2S), and sediments, have been removed from the water. Treated water containing dissolved activated oxygen continues flowing, through the flow space provided by the plurality of slots of the strainer portion of the combined strainer-distributor basket 24, into the riser tube 22. The water flows through the riser tube 22 from lower portion of the treatment tank body 70, to the 4-cycle control valve 16.

In the normal flow configuration, the 4-cycle control valve 16 allows treated water containing dissolved activated oxygen to flow from the 4-cycle control valve 16, through the outlet port 20, and (in some embodiments) into a potable water plumbing system. The water flowing through the outlet port 20 has been treated; biofilm forming bacteria, iron, sulfides, sediments, and other contaminants from the original pressurized fluid source are eliminated. The treated water containing dissolved activated oxygen flows into and throughout the water plumbing system destroying and effectively eliminating bacterial biofilm infections in the water plumbing system downstream from the water treatment apparatus. The normal flow configuration of the pressurized water treatment apparatus allows for the continuous treatment of water for a period of approximately twenty-four to seventy-two hours before the pressurized water treatment apparatus must convert to another configuration; the length of this period is regulated by the 4-cycle control valve 16.

Referring now to FIG. 2 and FIG. 2a, the backwash configuration begins after the normal flow configuration and proceeds for a period of approximately three minutes for a typical water treatment apparatus. The timing, time period, flow rate and flow patterns are regulated by the 4-cycle control valve 16. While the pressurized water treatment apparatus is in the backwash configuration, the flow of water is reversed; meaning water flows down through the riser tube 22. This flow reversal is depicted by the flow arrows in FIG. 2 and FIG. 2a. Non-aerated and untreated source water flows through the inlet port 12, and the check valve 14, to the 4-cycle control valve 16. In an embodiment of the water treatment apparatus, in the backwash configuration, the 4-cycle control valve 16 allows source water to flow into the riser tube 22, instead of into the treatment tank body 18. The water continues to flow down the riser tube 22, into the combined strainer-distributor basket 24, out of the plurality of apertures of the distributor portion of the combined strainer-distributor basket 24, into the garnet gravel media 30 in the lower portion of the treatment tank body 70, up through the copper-zinc media 28 in the middle portion of the treatment tank body 60, to the 4-cycle control valve 16. The 4-cycle control valve 16 comprises a discharge port 32, which can allow the flow and release of captured or trapped materials, contaminants, sediments, and fluids.

When the pressurized water treatment apparatus is used in the backwash configuration, the 4-cycle control valve 16 allows the air from the compressed air pocket in the upper portion of the treatment tank body 50 to flow out of the discharge port 32 of the 4-cycle control valve 16.

The initial period of the backwash configuration is depicted in FIG. 2. When in the initial period of the backwash configuration, gases from the compressed air pocket 26 in the upper portion of treatment tank body 50 escapes rapidly through discharge port 32 creating an immediate reduction in flow resistance inside treatment tank body 18. Water flow through riser tube 22 increases to match the flowrate of the source water supply, water flows out of the plurality of apertures of the distributor portion of the combined strainer-distributor basket 24 in high volume, into the garnet gravel media 30 in the lower portion of the treatment tank body 70 and up through the copper-zinc media 28 in the middle portion of the treatment tank body 60. The entire volume of copper-zinc media 28 is lifted vertically toward the upper portion of the treatment tank body 50. All of the individual granules of copper-zinc media 28 are separated, releasing trapped bacteria and other contaminants from deep within the copper-zinc media 28. Water flowing upward carries dislodged bacteria and other contaminants into the upper portion of the water treatment tank 50, completing the initial period of the backwash configuration.

The remainder period of the backwash configuration is depicted in FIG. 2a. When in the remainder period of the backwash configuration, water flowing upward through treatment tank body 18 flows into and through the 4-cycle control valve 16 and out of the discharge port 32. Water flow rate through the pressurized water treatment apparatus slows in accordance to normal water flow resistance. Granules of the copper-zinc media 28 are agitated and in close contact with one another which causes rubbing, scouring, and abrasion. This rubbing, scouring, and abrasion, along with the upward motion caused by the flowing water, causes biofilm-forming bacteria and other contaminants that are fastened to the copper-zinc media 28 to become detached from the particles of the copper-zinc media 28. Once detached from the particles of the copper-zinc media 28, those biofilm-forming bacteria and other contaminants are carried away with the flow of water, upwards through the upper portion of the treatment tank body 50, towards the 4-cycle control valve 16 where they are discharged through the discharge port 32 of the 4-cycle control valve 16. The discharge released from the discharge port 32 of the 4-cycle control valve 16 can be monitored, and, in some embodiments of the invention, the period in which the pressurized water treatment apparatus is in backwash configuration can be extended or shortened to achieve a clear discharge (which indicates that the backwash configuration has succeeded in washing out remaining contaminants).

Referring now to FIG. 3 and FIG. 3a, after use in the backwash configuration, the pressurized water treatment apparatus may be converted to the air injection configuration. The pressurized water treatment apparatus being in the air injection configuration involves the introduction of water and uncontaminated air into the pressurized water treatment apparatus. In an embodiment of the invention, the air injection configuration is typically used for a period of ten minutes, although this period differs in different embodiments. While used in the air injection configuration, the timing, period length, flow rate and flow pattern can be regulated by the 4-cycle control valve 16. The 4-cycle control valve 16 comprises an air injector assembly 34. The integrated air injector assembly 34 is controlled by the 4-cycle control valve 16 and adds the intake of air to the water treatment apparatus. The air injector assembly 34 comprises a screen 38, a venturi nozzle 36, a venturi throat 40, a bore 42 and a one-way pressure sensitive valve 44. When water flows from the inlet port 12 to the 4-cycle control valve 16, the 4-cycle control valve 16 directs water to flow through screen 38 for removing particulate matter in the water that could possibly clog the venturi nozzle 36. As non-aerated source water passes from the venturi nozzle 36 to the venturi throat 40, a pressure differential is created at the bore 42. The bore 42 accepts a one-way pressure sensitive valve 44. The pressure sensitive valve 44 opens in response to the pressure differential at the throat 40, which allows ambient air to enter the bore 42. The one-way pressure sensitive valve 44 allows air to flow into the pressurized water treatment apparatus and prevents water and air from flowing out. The one-way pressure sensitive valve 44 may be, for example, a Light Spring Schrader Valve color coded white, orange or green. The 4-cycle control valve 16 allows the air and water from air injector assembly 34 to flow into the upper portion of the treatment tank body 50. Pressure inside the treatment tank body 18 drops as water flows from the upper portion of the treatment tank body 50, through the copper-zinc media 28 in the middle portion of the treatment tank body 60, through the garnet gravel media 30 in the lower portion of the treatment tank body 70, through the plurality of slots of the strainer portion of the combined strainer-distributor basket 24, up through the riser tube 22, to the 4-cycle control valve 16, and out of the discharge port 32. As air and water flows into the upper portion of the treatment tank body 50, air remains to form an air pocket 26, and water rinses the copper-zinc media 28. In air injection configuration, the 4-cycle control valve 16 regulates the water level above the copper-zinc media 28; in one embodiment of the invention, the water level is set 6 inches above the water treatment filter media 28 when the air injection configuration is terminated.

Referring now to FIG. 4, after use in the air injection configuration, the pressurized water treatment apparatus may be converted to the rinse configuration. In an embodiment of the invention, the rinse configuration is in use for a period of one minute. While used in the rinse configuration, the timing, period length, flow rate and flow pattern can be regulated by the 4-cycle control valve 16. Non-aerated source water flows into the inlet port 12 towards the 4-cycle control valve 16. The check valve 14 allows water to flow toward the 4-cycle control valve 16 but prevents any air from returning to the non-aerated fluid source. In the rinse configuration, the 4-cycle control valve 16 allows the flow of water into the upper portion of the treatment tank body 50. The air pocket is compressed as the water flows from the upper portion of the treatment tank body 50 through the copper-zinc media 28 in the middle portion of the treatment tank body 60, through the garnet gravel media 30 in the lower portion of the treatment tank body 70, through the plurality of slots of the strainer portion of the combined strainer-distributor basket 24, up through the riser tube 22, to the 4-cycle control valve 16, and out of the discharge port 32. During this process, the copper-zinc media 28 is compressed into a tightly packed state and the pressure in the treatment tank body 50 rises until a cut-off point, that cut-off point being regulated by the pressurized water source.

After the pressurized water treatment apparatus has been used in the rinse configuration, the pressurized water treatment apparatus may be converted to the normal flow configuration. The four flow configurations: normal flow configuration, backwash configuration, air injection configuration, and rinse configuration, may be used in a cycle to maintain the efficiency of the pressurized water treatment apparatus.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A pressurized water treatment apparatus comprising,
an inlet port, wherein the inlet port is configured to be connected to a pressurized fluid source;
a check valve, the check valve being connected to the inlet port to prevent the flow of materials into the pressurized fluid source;
a 4-cycle control valve, the 4-cycle control valve being connected to the inlet port, the 4-cycle control valve regulating the flow of fluid through the normal flow configuration, the backwash configuration, the air injection configuration and the rinse configuration;
an air injector assembly, the air injector assembly being an integrated portion of the 4-cycle control valve;
a one-way pressure sensitive valve, the one way pressure sensitive valve being connected to the air injector assembly;
a treatment tank body, the treatment tank body comprising an upper portion and a middle portion and a lower portion, the upper portion of the treatment tank body being connected to the 4-cycle control valve;
a compressed air pocket, the compressed air pocket being located within the upper portion of the treatment tank body;
a copper-zinc media, the copper-zinc media comprising a high-purity medium copper-zinc media, the copper-zinc media having a density of at least 100 lbs per cubic foot, the copper-zinc media comprising a plurality of particles, the copper-zinc media being located within the middle portion of the treatment tank body;
a garnet gravel media, the garnet gravel media comprising a plurality of particles of garnet gravel, the garnet gravel media being located below the copper-zinc media within the lower portion of the treatment tank body;
a riser tube, the riser tube being located within the treatment tank body, the riser tube being connected to the 4-cycle control valve, the riser tube extending from the 4-cycle control valve through the upper portion of the treatment tank body and through the copper-zinc media in the middle portion of the treatment tank body and the garnet gravel media in the lower portion of the treatment tank body;
a combined strainer-distributor basket, the combined strainer-distributor basket being connected to the riser tube in the lower portion of the treatment tank body, the combined strainer-distributor basket being surrounded by the garnet gravel media, the combined strainer-distributor basket defining an inner volume and that inner volume being in fluid connection with the riser tube, the combined strainer-distributor basket having a total flow area between two and ten square inches; and
an outlet port, the outlet port being connected to the 4-cycle control valve, the outlet port connecting the 4-cycle control valve to a potable water plumbing system.

2. The pressurized water treatment apparatus of claim 1, wherein the pressurized fluid source comprises private or public water supply.

3. The pressurized water treatment apparatus of claim 1, wherein the outlet port may be connected to a potable water plumbing system.

4. The pressurized water treatment apparatus of claim 1, wherein the 4-cycle control valve comprises a Fleck 2510-SXT-AIO control valve.

5. The pressurized water treatment apparatus of claim 1, wherein the air injector assembly is an integrated portion of the Fleck 2510-SXT-AIO control valve.

6. The pressurized water treatment apparatus of claim 1, wherein the one-way pressure sensitive valve comprises a Light Spring Schrader Valve.

7. The pressurized water treatment apparatus of claim 1, wherein the treatment tank body comprises a Clack 948 Mineral Tank.

8. The pressurized water treatment apparatus of claim 1, wherein the compressed air pocket comprises ambient air.

9. The pressurized water treatment apparatus of claim 1, wherein the copper-zinc media comprises high-purity medium copper-zinc granules.

10. The pressurized water treatment apparatus of claim 1, wherein the copper-zinc media comprises high-purity medium copper-zinc granules with a density between 120 lbs per cubic foot and 220 lbs per cubic foot.

11. The pressurized water treatment apparatus of claim 1, wherein the copper-zinc media comprises between 40 lbs and 80 lbs of high-purity medium copper-zinc granules.

12. The pressurized water treatment apparatus of claim 1, wherein the garnet gravel media comprises garnet.

13. The pressurized water treatment apparatus of claim 1, wherein the garnet gravel media comprises Garnet #6.

14. The pressurized water treatment apparatus of claim 1, wherein the garnet gravel media comprises between 25 lbs and 75 lbs of garnet gravel media.

15. The pressurized water treatment apparatus of claim 1, wherein the riser tube comprises an interior diameter of between 15/16 inch and an outside diameter of 1 1/16 inches.

16. The pressurized water treatment apparatus of claim 1, wherein the combined strainer-distributor basket comprises a width of between 1.80 inches and 2.70 inches.

17. The pressurized water treatment apparatus of claim 1, wherein the combined strainer-distributor basket allows a backwash flow rate of at least 7 GPM.

18. The pressurized water treatment apparatus of claim 1, wherein the combined strainer-distributor basket comprises a plurality of apertures, each individual aperture having a diameter that is smaller than the diameter of the plurality of gravel particles.

19. The pressurized water treatment apparatus of claim 1, wherein the total flow area of the combined strainer-distributor basket is between 3.30 and 4.30 square inches.

20. The pressurized water treatment apparatus of claim 1, wherein the total flow area of the combined strainer-distributor basket is at least three times greater than the flow area of the riser tube.

21. The pressurized water treatment apparatus of claim 1, wherein the total flow area of the combined strainer-distributor basket is at least five times greater than the flow area of the riser tube.

22. The pressurized water treatment apparatus of claim 1, wherein the plurality of apertures of the distributor portion of the combined strainer-distributor basket defines diameter apertures between 0.1 inch and 0.375 inches.

23. A pressurized water treatment apparatus comprising,
an inlet port, wherein the inlet port is configured to be connected to a pressurized fluid source;
a check valve, the check valve being connected to the inlet port to prevent the flow of materials into the pressurized fluid source;
a 4-cycle control valve, the 4-cycle control valve being connected to the inlet port, the 4-cycle control valve regulating the flow of fluid through the normal flow configuration, the backwash configuration, the air injection configuration and the rinse configuration;
an air injector assembly, the air injector assembly being an integrated portion of the 4-cycle control valve;
a one-way pressure sensitive valve, the one-way pressure sensitive valve being connected to the air injector assembly;
a treatment tank body, the treatment tank body comprising an upper portion and a middle portion and a lower portion, the upper portion of the treatment tank body being connected to the 4-cycle control valve;
a compressed air pocket, the compressed air pocket being located within the upper portion of the treatment tank body;
a copper-zinc media, the copper-zinc media comprising a plurality of particles of high-purity medium copper-zinc granules, the high-purity medium copper-zinc granules having a density of at least 100 lbs per cubic foot, the high-purity medium copper-zinc granules being located within the middle portion of the treatment tank body;
a garnet gravel media, the garnet gravel media comprising a plurality of particles of garnet gravel, the garnet gravel media being located below the copper-zinc media within the lower portion of the treatment tank body;
a riser tube, the riser tube being located within the treatment tank body, the riser tube being connected to the 4-cycle control valve, the riser tube extending from the 4-cycle control valve through the upper portion of the treatment tank body and through the copper-zinc media in the middle portion of the treatment tank body and the garnet gravel media in the lower portion of the treatment tank body;
a combined strainer-distributor basket, the combined strainer-distributor basket being connected to the riser tube in the lower portion of the treatment tank body, the combined strainer-distributor basket being surrounded by the garnet gravel media, the combined strainer-distributor basket defining an inner volume and that inner volume being in fluid connection with the riser tube, the combined strainer-distributor basket comprising a plurality of apertures, the combined strainer-distributor basket having a total flow area between two and six times the riser tube flow area; and
an outlet port, the outlet port being connected to the 4-cycle control valve, the outlet port connecting the 4-cycle control valve to a potable water plumbing system.
